(19) United States
(12) Patent Application Publication
(10) Pub. No.: US 2004/0134106 A1
(43) Pub. Date: Jul. 15, 2004

(54) Customer self-index system for beverage container

(76) Inventor: Siyong Kim, Gainesville, FL (US)

Correspondence Address: Siyong Kim, 3627 NW 64th Lane, Gainesville, FL, 32653, US

(21) Appl. No.: 10/689,914

(22) Filed: Oct. 21, 2003

Related U.S. Application Data
(60) Provisional application No. 60/419,859, filed on Oct. 21, 2002.

(51) Int. Cl. G09F 3/00

(52) U.S. Cl. 40/310; 40/595

(57) ABSTRACT

A process for a customer to mark an index by him/herself in any disposable beverage container comprising:

a) drawings of arrays to accommodate index-elements and

b) drawings of index-elements.

### BACKGROUND OF THE INVENTION

Nowadays, huge amount of beverage is sold in disposable containers such as plastic/paper cup, plastic/glass bottle, and can. Many people drink water, soda, or beer in containers in restaurants, at works, in the cars, and almost everywhere. When, however, multiple people drink in a limited space, each individual often forgets which one is his or hers because there is no easy way to distinguish those containers. Considering many diseases can be transmitted through saliva, it can be a threat to public health for someone to unknowingly switch his/her beverage with others and drink it. This problem cannot be easily solved in current system.

### DESCRIPTION OF THE INVENTION

The present invention comprises a customer self-indexing process in that an indexing system is provided on the disposable beverage container and a customer easily make an index on it by him/herself to distinguish his/her own from others, and a method for the realization of the concept of customer self-indexing process. The method is described as follow:

Multiple arrays of index-elements are made on paper. The paper is partially cut along the border and horizontal centerlines of each element of array, and then lightly attached around the container. Index-elements can be pictures (see FIG. 1), letters (for example, English alphabet in USA), numbers, cartoons, symbols, characters, and so on. Customers can pick any elements (for example, their initials when elements are letters) and tear off halves of them using their fingernails, forks, spoons, or something else available to make an index on their container. Due to partial pre-cut and light attachment, elements in the array can be easily torn off. Arrays and index-elements can also be printed directly on the container instead on paper in a way that they can be either scratched or peeled off with relative ease.

### BRIEF DESCRIPTION OF THE DRAWINGS

FIG. 1 depicts the customer self-index system with pictures as index-elements applied to disposable bottle.

### DETAILED DESCRIPTION OF THE INVENTION

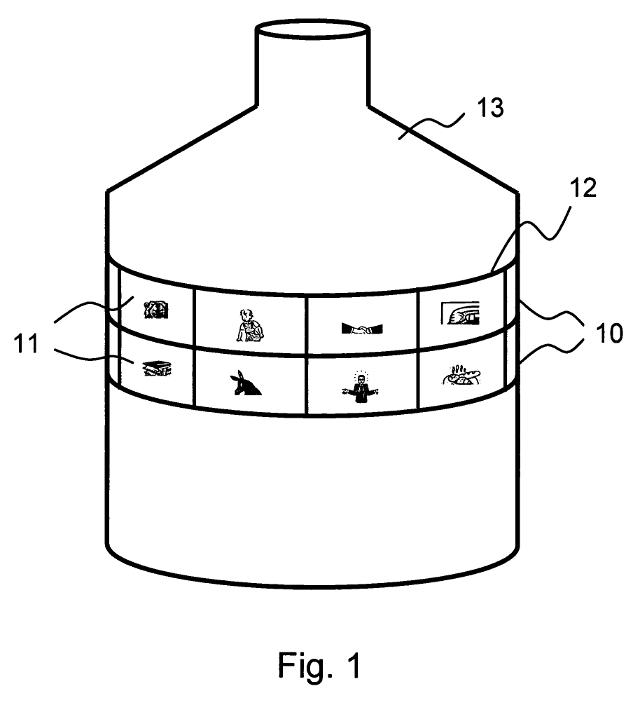

FIG. 1 illustrates an example of customer self-index system provided for disposable bottle. The invention consists the arrays 10, and the index-elements 11 provided on the paper (or plastic) sheet 12. The number of arrays 10 can vary depending on many factors such as space and use of container. Index-elements 11 are printed images such as pictures, letters, numbers, cartoons, symbols, characters, and so on. The number of index-elements 11 can also vary depending on many factors such as type of image, space, and use of container. The paper (or plastic) sheet 12 is partially cut along the border and horizontal centerlines of each element of array, and then lightly attached to the disposable beverage container 13. On the process of customer self-indexing, a customer chooses some of index-elements 11 they want (for example, their initials when index-elements are letters) and partially tears off them using his/her fingernails, forks, spoons, or something else available to make the self-index on his/her container. Alternatively, the arrays 10 and the index-elements 11 can be printed directly on the disposable beverage container 13 instead on the paper (or plastic) sheet 12. The index-elements 11 are lightly printed so that they can be either scratched or peeled off with relative ease.

The invention is highly valuable in that it brings a new process that customers actively prevent their beverages from being switched with others, resulting in significant help to public health.

What is claimed is:

1. A process for a customer to mark an index by him/herself in any disposable beverage container comprising:
a) drawings of arrays to accommodate index-elements and
b) drawings of index-elements.

2. The drawings of claim 1 wherein said the drawings of arrays are arrays printed on a paper (alternatively plastic) sheet lightly attached to a disposable beverage container with partial pre-cut along the border and horizontal center lines of each element of arrays.

3. The drawings of claim 1 wherein said the drawings of arrays are horizontal circular arrays lightly printed directly on a disposable beverage container.

4. The drawings of claim 1 wherein said the drawings of index-elements are images such as pictures, letters, numbers, cartoons, symbols, characters, and so on, printed on the paper (alternatively plastic) sheet of claim 2.

5. The drawings of claim 1 wherein said the drawings of index-elements are images such as pictures, letters, numbers, cartoons, symbols, characters, and so on, printed directly on the disposable beverage container of claim 3.
